(19) United States
(12) Patent Application Publication
(10) Pub. No.: US 2010/0284367 A1
(43) Pub. Date: Nov. 11, 2010

(54) System and Method for Handovers in a Multi-Carrier Wireless Communications System

(75) Inventors: Changhoi Koo, Plano, TX (US); Sean Michael McBeath, Keller, TX (US)

Correspondence Address: Slater & Matsil, L.L.P., 17950 Preston Road, Suite 1000, Dallas, TX, 75252, US

(73) Assignee: FutureWei Technologies, Inc., Plano, TX (US)

(21) Appl. No.: 12/615,117

(22) Filed: Nov. 9, 2009

Related U.S. Application Data
(60) Provisional application No. 61/112,947, filed on Nov. 10, 2008.

(51) Int. Cl. H04W 36/00

(52) U.S. Cl. 370/331

(57) ABSTRACT

A system and method for handovers in multi-carrier wireless communications systems is provided. A method for communications device operation includes computing a bandwidth requirement, transmitting a handover request to a server controller, receiving a response responsive to the handover request, and in response to determining that the handover request was granted, initiating a handover. The handover request includes the bandwidth requirement.

This application claims the benefit of U.S. Provisional Application No. 61/112,947, filed on Nov. 10, 2008, entitled “Method and Apparatus for Secondary Carrier Usage in Multi-Carrier System,” which application is hereby incorporated herein by reference.

### TECHNICAL FIELD

The present invention relates generally to wireless communications, and more particularly to a system and method for handovers in multi-carrier wireless communications systems.

### BACKGROUND

Generally, in a multi-carrier wireless communications system communications between a mobile station (MS) and its serving base station (BS) occur over one or more carriers allocated for use by a MS by its serving BS. For example, a multi-carrier wireless communications system may have one primary channel and a plurality of secondary channels. The primary channel may be dedicated primarily to control traffic, while the secondary channels may be used mainly for data traffic.

In such a system, the primary channel may be allocated for use by all of the MSs, while individual MSs may be allocated subsets of the secondary channels based on their bandwidth requirements. In addition to the bandwidth requirements, other considerations to be used in allocating carriers to a MS may include a priority of the MS, a priority of a user of the MS, any quality of service (QoS) requirements, a service subscription plan paid for by the user of the MS, available bandwidth, system load, carrier allocation history for the MS, and so forth.

Typically, the use of multi-carriers may help to reduce interference between communications to and from the various MSs. For example, transmissions occurring in one carrier may have very little impact on transmissions occurring in another carrier, even if orthogonal modulation and coding techniques are not used. Furthermore, the use of multi-carriers may help improve bandwidth utilization since a MS may be allocated bandwidth (i.e., a number of carriers) based on bandwidth requirements of the MS.

### SUMMARY OF THE INVENTION

These and other problems are generally solved or circumvented, and technical advantages are generally achieved, by embodiments of a system and method for handovers in multi-carrier wireless communications systems.

In accordance with an embodiment, a method for communications device operation in a multi-carrier communications system is provided. The method includes computing a bandwidth requirement, transmitting a handover request to a server controller, and receiving a response responsive to the handover request. The handover request includes the bandwidth requirement. The method also includes in response to determining that the handover request was granted, initiating a handover.

In accordance with another embodiment, a method for server controller operation is provided. The method includes receiving a handover request from a communications device, the handover request includes a bandwidth requirement, requesting a carrier allocation from each of one or more potential target controllers, receiving the carrier allocation from each of the one or more potential target controllers, selecting a target controller from the one or more potential target controllers, and sending a response to the handover request to the communications device. Each carrier allocation is based on the bandwidth requirement, the selecting is based on the carrier allocations from the one or more potential target controllers, and the response comprises the carrier allocation from the selected target controller.

In accordance with another embodiment, a method for target controller operation is provided. The method includes receiving a carrier allocation request from a serving controller, the carrier allocation request includes a secondary carrier requirement of a communications device, determining a carrier allocation based on the carrier allocation request, and transmitting the carrier allocation to the serving controller.

In accordance with another embodiment, a method for server controller operation is provided. The method includes requesting a carrier allocation from one or more potential target controllers, receiving one or more carrier allocations from the one or more potential target controllers, selecting a target controller from the one or more potential target controllers, and sending a handover request to the communications device. The carrier allocation is based on a secondary carrier requirement of a communications device, and the selecting is based on the one or more carrier allocations from the one or more potential target controllers.

An advantage of an embodiment is that carrier allocations consistent with MS requirements are made prior to allowing a handover to commence, which may help to improve a likelihood that the handover will complete successfully. This may help to maintain a high connection rate, expedite completion of the handover, as well as good user satisfaction.

A further advantage of an embodiment is that since carrier allocations are made prior to allowing a handover to commence, a serving BS of a MS may be able to select a target BS for the MS that best meets the needs of the MS. This may help to maintain good user satisfaction since a likelihood of a drop in performance due to a carrier allocation that is significantly smaller than the MS's current carrier allocation is less likely.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1a is a diagram of a multi-carrier wireless communications system;

FIG. 1b is a frequency plot of carriers in a multi-carrier wireless communications system;

FIG. 2a is a diagram of a message exchange in a MS initiated handover in a single carrier wireless communications system;

FIG. 2b is a diagram of a message exchange in a BS initiated handover in a single carrier wireless communications system;

FIG. 3a is a diagram of a BS;

FIG. 3b is a diagram of a MS;

FIG. 4a is a diagram of a message exchange in a MS initiated handover in a multi-carrier wireless communications system;

FIG. 4b is a diagram of a message exchange in a BS initiated handover in a multi-carrier wireless communications system;

FIG. 5a is a flow diagram of MS operations in a MS initiated handover in a multi-carrier wireless communications system;

FIG. 5b is a flow diagram of serving BS operations in a MS initiated handover in a multi-carrier wireless communications system;

FIG. 5c is a flow diagram of target BS operations in a MS initiated handover in a multi-carrier wireless communications system;

FIG. 6a is a flow diagram of serving BS operations in a serving BS initiated handover in a multi-carrier wireless communications system; and

FIG. 6b is a flow diagram of MS operations in a serving BS initiated handover in a multi-carrier wireless communications system.

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a multi-carrier wireless communications system, such as those compliant to IEEE 802.16e and IEEE 802.16m technical specifications. The invention may also be applied, however, to other multi-carrier wireless communications systems that allow for handovers of mobile stations using multiple carriers, such as WiMAX, Long Term Evolution, Long Term Evolution-Advanced, and so forth.

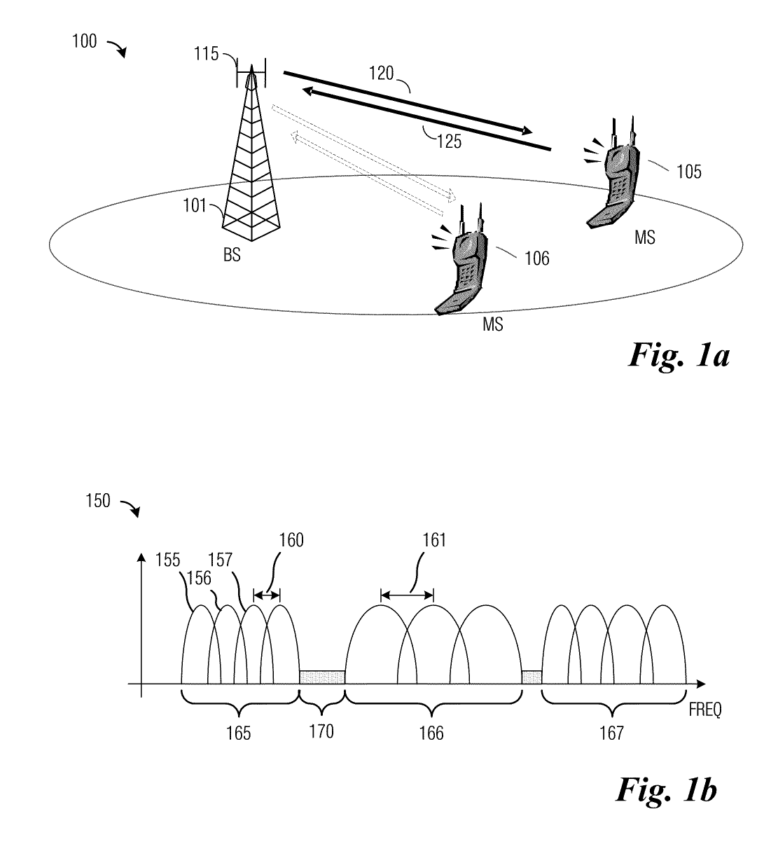

FIG. 1a illustrates a multi-carrier wireless communications system 100. Multi-carrier wireless communications system 100 includes a BS 101 and a MS 105 and MS 106, which may be mobile or fixed. BS 101, MS 105, and MS 106 may communicate using multi-carrier wireless communications. In multi-carrier wireless communications, a MS, such as MS 105 or MS 106, may be allocated as primary carrier and potentially one or more secondary carriers over which it may send and/or receive transmissions. Typically, the primary carrier is shared by all MSs. The MS may have exclusive access to its allocated secondary carriers or it may share access of the allocated secondary carriers with other MSs.

BS 101 has a plurality of transmit antennas 115, while MS 105 and MS 106 may have one or more receive antennas. BS 101 sends control information and data to MS 105 through DL carriers 120, while MS 105 sends control information and data to BS 101 through uplink (UL) carriers 125. BS 101 and MS 106 may also communicate over similar carriers.

In general, a BS, such as BS 101, may also be referred to as a base transceiver station, a NodeB, an enhanced NodeB, and so forth. Similarly, a MS, such as MS 105, may also be referred to as a User Equipment, subscriber unit, a user, a subscriber, a terminal, and so on.

FIG. 1b illustrates a frequency plot 150 of carriers in a multi-carrier wireless communications system. A multi-carrier wireless communications system may utilize a number of carriers. One of the carriers may be referred to as a primary carrier, while the remainder of the carriers may be referred to as secondary carriers. The primary carrier may be used to carry control and/or data traffic, while a main purpose of the secondary carriers may be to carry data traffic. For generality, the secondary carriers may be referred to simply as carriers. The carriers may be adjacent to one another, such as carriers 155, 156, and 157. The carriers may be spaced apart by a carrier spacing (for example, carrier spacings 160 and 161) so that information carried within one carrier does not significantly interfere with information carried in another carrier.

The carriers may be grouped into multiple carrier groups, such as groups 165, 166, and 167. The groups may be adjacent to one another or they may be separated. For example, carrier groups may be place around a frequency band that is protected, a significant source of noise or interference, used by devices that are sensitive to interference, or otherwise should not be used. For example, carrier groups 165 and 166 are located on either side of frequency band 170.

The carriers in a multi-carrier wireless communications system may all have the same bandwidth. Alternatively, the carriers in a multi-carrier wireless communications system may have different bandwidths, with each carrier's bandwidth potentially being determined to maximize the usage efficiency of the available bandwidth, minimize bandwidth fragmentation, minimize interference and noise, and so forth. As shown in FIG. 1b, carriers in carrier group 165 are equal bandwidth carriers, as are carriers in carrier group 166. However, carriers in carrier group 167 may have different bandwidths.

The primary carrier may be adjacent to the secondary carriers, or it may be located in a totally different frequency band from the secondary carriers. For example, carrier 155 may be the primary carrier. In an embodiment, the primary carrier may be a secondary carrier specially designated as a primary carrier. In an alternative embodiment, the primary carrier may have the same amount of bandwidth as the secondary carriers. In yet another alternative embodiment, the primary carrier may have greater bandwidth than any single secondary carrier.

As a MS moves around, a received signal strength at the MS of transmissions made by its serving BS may be a function of a distance between the MS and the serving BS. If the MS moves towards an edge of a coverage area of a BS that is serving it, the signal strength of transmissions may drop to a level wherein it may become more difficult for the BS to maintain an acceptable data rate for the MS. Similarly, the MS may experience more difficulty in maintaining an acceptable data rate in its transmissions to the BS. In these situations, an alternate BS may become a better candidate for serving the MS than the MS's current serving BS. Then, the MS may be a suitable candidate for a handover, wherein the MS's serving BS changes from its current serving BS to the alternate BS.

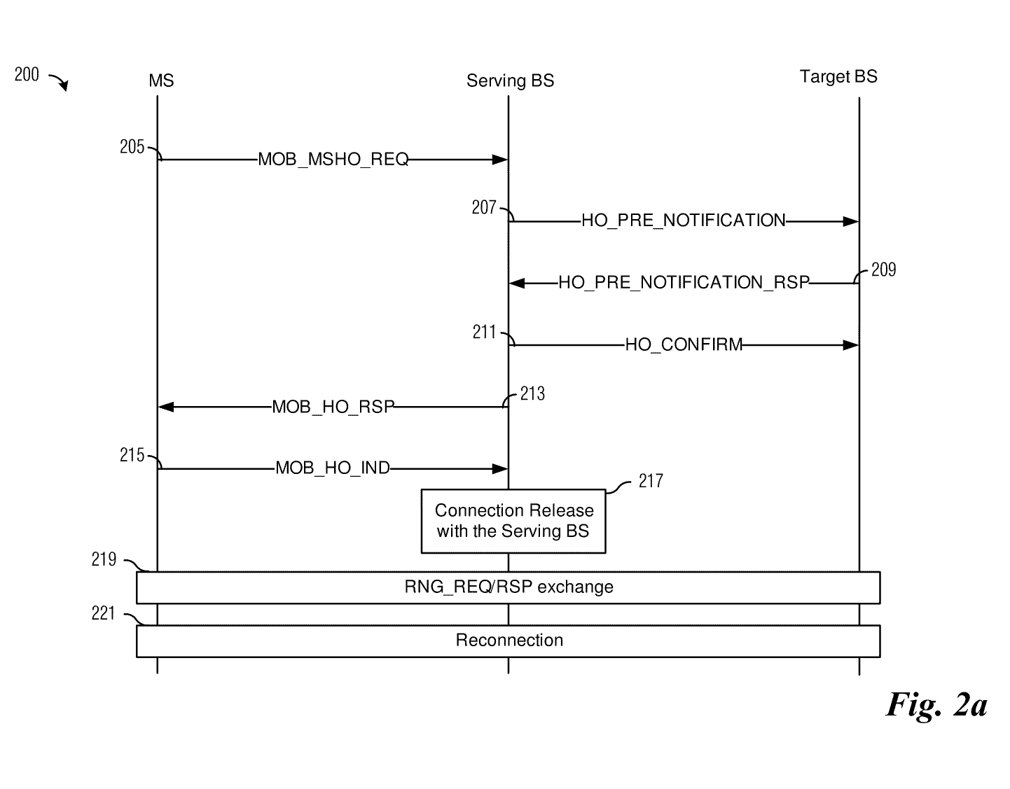

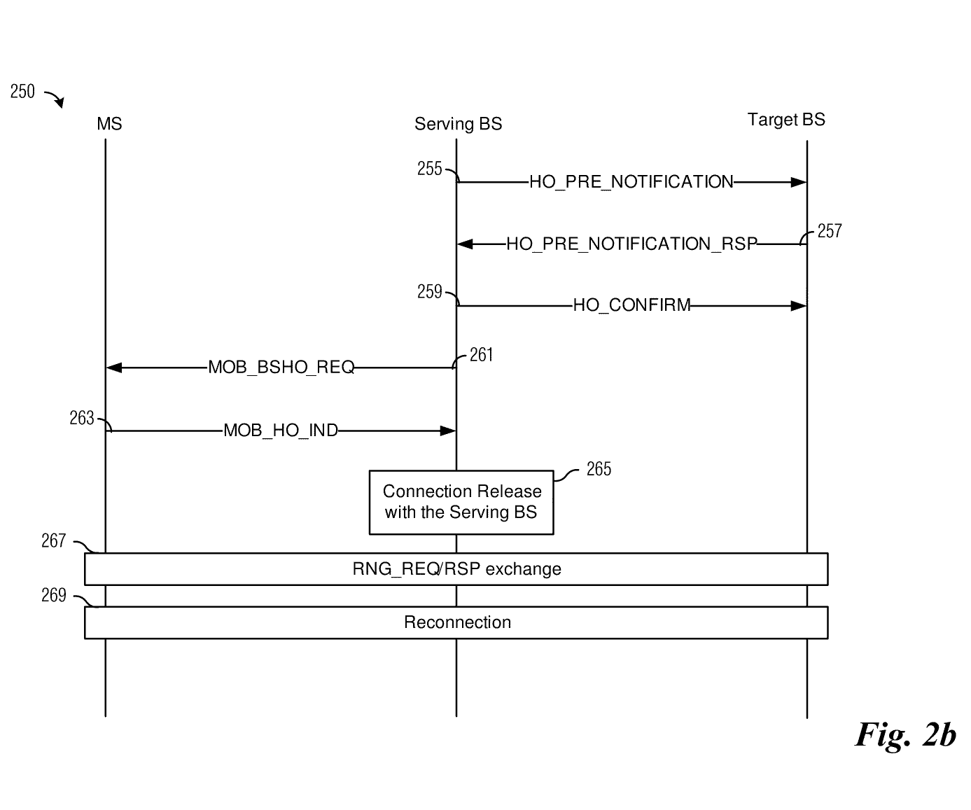

FIG. 2a illustrates a message exchange 200 in a MS initiated handover in a single carrier wireless communications system. Message exchange 200 may be illustrative of messages and operations occurring in a MS, a serving BS, and a target BS of a single carrier wireless communications system in a MS initiated handover, wherein the serving BS is the current serving BS of the MS and the target BS is a BS that is intended to be the serving BS of the MS after the handover completes.

Generally, in a single carrier wireless communications system, all of the MSs are allocated to use the single carrier and a variety of techniques such as time, frequency, and code division multiplexing may be used to help reduce interference between transmissions to and from the MSs. Therefore, in a handover situation, consideration may not need to be given to carrier allocations for MSs.

A MS initiated handover may begin with the MS transmitting a mobile station handover request (MOB_MSHO_REQ) message to its serving BS (event 205). The serving BS may then send a handover pre-notification (HO_PRE_NOTIFICATION) message to potential target BS(s) (event 207). Potential target BS(s) that may be capable of participating in the handover may transmit a response message (HO_PRE_NOTIFICATION_RSP) in response to the handover pre-notification message (event 209). The serving BS may select a target BS out of the possible target BS(s) that responded to the handover pre-notification message and send a handover confirm (HO_CONFIRM) message to the selected target BS, now referred to as a target BS (event 211).

The serving BS may send a response message (MOB_HO_RSP) in response to the handover request message from the MS (event 213) and the MS may send a handover indicator (MOB_HO_IND) in a message to the serving BS (event 215). The serving BS may then begin operations to release an existing connection with the MS (block 217), while the MS and the target BS may exchange ranging request (RNG_REQ) and response (RNG_RSP) messages to exchange system information and parameters (block 219). Finally, a connection between the MS and the target BS may be established (block 221).

FIG. 2b illustrates a message exchange 250 in a BS initiated handover in a single carrier wireless communications system. Message exchange 250 may be illustrative of messages and operations occurring in a MS, a serving BS, and a target BS of a single carrier wireless communications system in a BS initiated handover, wherein the serving BS is the current serving BS of the MS and the target BS is a BS that is intended to be the serving BS of the MS after the handover completes.

A BS initiated handover may begin with the serving BS sending a handover pre-notification (HO_PRE_NOTIFICATION) message to potential target BS(s) (event 255). Potential target BS(s) that may be capable of participating in the handover may transmit a response message (HO_PRE_NOTIFICATION_RSP) in response to the handover pre-notification message (event 257). The serving BS may select a target BS out of the possible target BS(s) that responded to the handover pre-notification message and send a handover confirm (HO_CONFIRM) message to the selected target BS, now referred to as a target BS (event 259).

The serving BS may transmit a base station handover request (MOB_BSHO_REQ) message to the MS (event 261) to which, the MS may send a handover indicator (MOB_HO_IND) in a message to the serving BS (event 263). The serving BS may then begin operations to release an existing connection with the MS (block 265), while the MS and the target BS may exchange ranging request (RNG_REQ) and response (RNG_RSP) messages to exchange system information and parameters (block 267). Finally, a connection between the MS and the target BS may be established (block 269).

However, in a multi-carrier wireless communications system, consideration may need to be given to carriers allocated to a MS when a handover is to take place. This includes both the primary carrier and the secondary carriers. However, since the primary carrier may be used by all MSs, the handover process may need to only consider the allocation of the secondary carriers. For example, if a MS is allocated five carriers (secondary carriers) to meet its bandwidth requirements, and a target BS may only be able to allocate three carriers (secondary carriers) to the MS, then the bandwidth requirements of the MS may not be met by the target BS. Furthermore, a serving BS may select a target BS out of potential target BSs by evaluating the carriers that they may be able to allocate to the MS.

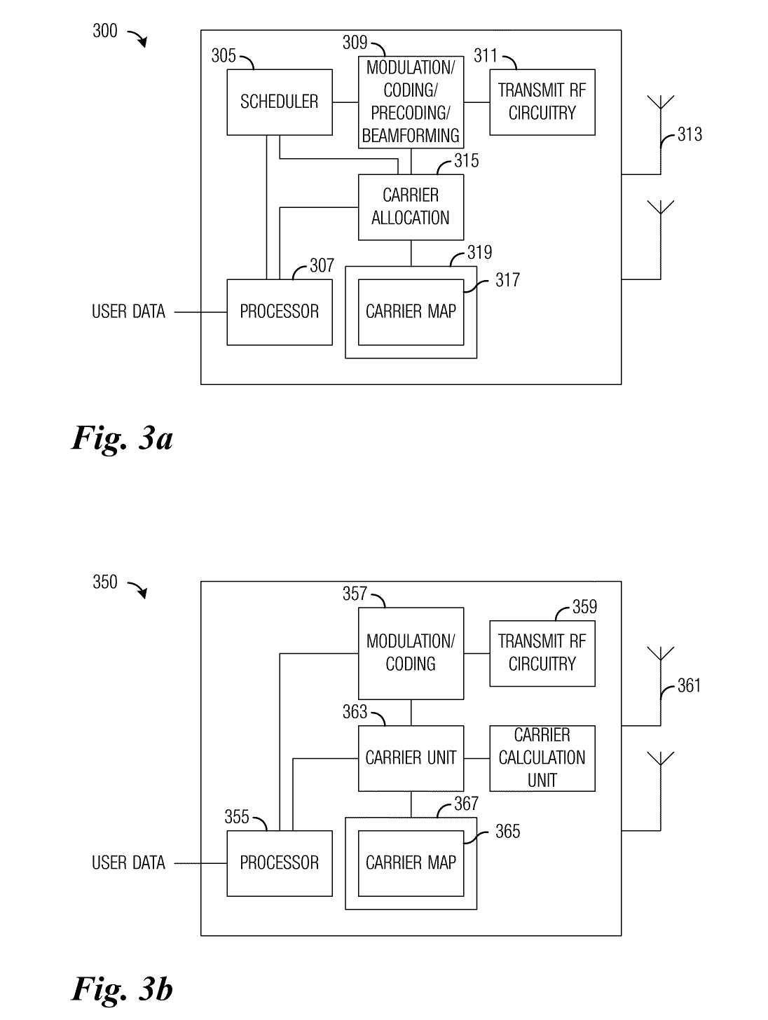

FIG. 3a illustrates a BS 300. BS 300 may be a BS in a multi-carrier wireless communications system and may take into consideration multi-carrier aspects when performing a handover for a MS. BS 300 includes a scheduler 305 that may be used to decide which MSs will transmit in a given time/frequency opportunity. Scheduler 305 may receive data from a processor 307 in the form of bits, symbols, packets, or so forth. Scheduler 305 may use any of a wide range of known scheduling disciplines in the literature including round robin, maximum sum rate, proportional fair, minimum remaining processing time, or maximum weighted sum rate.

Data for MSs selected for transmission may be processed by modulation/coding/precoding/beamforming block 309 to convert the data to transmitted symbols. Modulation/coding/precoding/beamforming block 309 may also add redundancy for the purpose of assisting with error correction and/or error detection. A modulation and coding scheme implemented in modulation and coding block may be chosen based in part on information about the channel quality information feedback. Modulation/coding/precoding/beamforming block 309 may also be used to precode the data or map the data onto a beamforming vector. The precoded or beamformed outputs may be prepared for transmission by transmit radio frequency (RF) circuitry 311 and then may be transmitted to the MSs by antenna(s) 313. Preparation by transmit RF circuitry 311 may include digital-to-analog conversion, filtering, amplification, and so forth.

Modulation/coding/precoding/beamforming block 309 may also place the data into carriers allocated to the MSs using carrier allocation information provided by carrier allocation unit 315. The carrier allocation information, for example, may specify which carriers are allocated to the MSs. Modulation/coding/precoding/beamforming block 309 may make use of the carrier allocation information to modulate the data into appropriate carriers. Information regarding the allocated carriers may be stored in a carrier map 317, which may be stored in a memory 319, for example.

Carrier allocation unit 315 may also be used to make allocations of carriers to MSs based on the MSs' bandwidth requirements. For example, a MS may request a certain amount of bandwidth. Carrier allocation unit 315 may then determine if sufficient bandwidth is available and if sufficient bandwidth is available, allocate carriers to the MS. If sufficient bandwidth is not available, carrier allocation unit 315 may decide how much bandwidth (e.g., carriers) to allocate to the MS. Carrier (bandwidth) allocation may be based on factors such as MS priority, MS QoS requirements, MS historical usage patterns, user priority, communications system conditions, and so forth.

Carrier allocation as performed by carrier allocation unit 315 may be contiguous or non-contiguous. For example, if BS 300 allocates four carriers to a MS, carrier allocation unit 315 may allocate four contiguous carriers to the MS. Alternatively, carrier allocation unit 315 may allocate three contiguous carriers and one non-contiguous carrier, two sets of two contiguous carriers, or four non-contiguous carriers to the MS. Additionally, carrier allocation unit 315 may make carrier allocations to equally load the carriers to as great a degree as possible.

FIG. 3b illustrates a MS 350. MS 350 may be a MS in a multi-carrier wireless communications system and may make use of multi-carriers allocated to it when receiving and/or transmitting information. MS 350 includes a processor 355 that may used to process incoming and outgoing information. A modulation and coding unit 357 may be used to convert data into transmission symbols. Modulation and coding unit 357 may also add redundancy for the purpose of assisting with error correction and/or error detection.

The transmission symbols (output of modulation and coding unit 357) may then be provided to transmit RF circuitry 359 to prepare the transmission symbols for transmission using antenna(s) 361. Preparation by transmit RF circuitry 359 may include digital-to-analog conversion, filtering, amplification, and so forth.

Modulation and coding unit 357 may also place the data into carriers allocated to MS 350 using carrier allocation information provided by carrier unit 363. The carrier allocation information, for example, may specify which carriers are allocated to MS 350. Modulation and coding unit 357 may make use of the carrier allocation information to modulate the data into appropriate carriers. Information regarding the allocated carriers may be stored in a carrier map 365, which may be stored in a memory 367, for example. Carrier map 365 may differ from carrier map 317 in that only carriers allocated to MS 350 may be contained in carrier map 365.

Since the secondary carrier(s) is mainly intended for data traffic transmission, the MS should be allowed to try to negotiate the usage of the secondary carrier(s) with the target BS based on the target BS's status. For example, if the target BS does not allow the secondary carrier or does want to change the secondary carrier, the MS should follow the BS's direction. In addition, the MS should also be allowed to request the allocation of additional secondary carrier(s) from the target BS. Furthermore since the usage of the secondary carrier should be allowed and tightly scheduled by the target BS, occupancy time for the secondary carrier should be defined under negotiation with the target BS.

Table 1 lists information elements that may be added on incumbent messages as defined in the IEEE802.16e technical standards or in a new message. Even with a new message, the new message should have the same message format containing generic information. In one aspect, the embodiments present information elements that can be added on MOB_MSHO_REQ message.

TABLE 1
Required Information Elements for MOB_MSHO_REQ and
HO_PRE_NOTIFICATION messages.

| Syntax | | Size | Notes |
|---|---|---|---|
| DL_SC_FLAG | 1 | bit | Downlink secondary carrier |
| | | | include flag |
| NUM_DL_SC | 0 or 3 | bits | Number of required secondary |
| | | | carrier for downlink transmission |
| DL_SC_DURATION | 0 or 4 | bits | Required occupancy time |
| | | | for downlink (in unit of frame) |
| UL_SC_FLAG | 1 | bit | Uplink secondary carrier include |
| | | | flag |
| NUM_UL_SC | 0 or 3 | bits | Number of required secondary |
| | | | carrier for uplink transmission |
| UL_SC_DURATION | 0 or 4 | bits | Required occupancy time |
| | | | for uplink (in unit of frame) |

DL_SC_FLAG: If the MS requests to add secondary carrier(s) for downlink transmission during the handoff, the MS may set this field to “1.”

NUM_DL_SC: If the DL_SC_FLAG is set to “1,” this field may be used to specify a number of required secondary carrier(s) for downlink transmission.

DL_SC_DURATION: If the DL_SC_FLAG is set to “1,” this field may be used to specify a time duration for secondary carrier(s) for downlink transmission. Time duration may be measured in frame units, for example. If the MS wants to add secondary carrier(s) for downlink transmission without specifying a time duration, the MS may set “DL_SC_DURATION” to “1111.” When the “DL_SC_DURATION” is set to “1111,” the MS or BS may transmit a secondary carrier(s) release message to release the allocated secondary carrier(s).

UL_SC_FLAG: If the MS requests to add secondary carrier(s) for uplink transmission during the handoff, the MS may set this field to “1.”

NUM_UL_SC: If the UL_SC_FLAG is set to “1”, this field may be used to specify a number of required secondary carrier(s) for uplink transmission.

UL_SC_DURATION: If the UL_SC_FLAG is set to “1”, this field may be used to specify a time duration for secondary carrier(s) for uplink transmission Time duration may be measured in frame units, for example. If the MS wants to add secondary carrier(s) for uplink transmission without specifying a time duration, the MS may set “UL_SC_DURATION” to “1111.” When the “UL_SC_DURATION” is set to “1111,” the MS or BS may transmit a secondary carrier(s) release message to release the allocated secondary carrier(s).

Table 2 lists information elements that may be added on an incumbent message as defined in the IEEE802.16e technical standards or in a new message. Even with a new message, the new message should have the same message format containing generic information. In one aspect, the embodiments present information elements that can be added on MOB_BSHO_REQ, MOB_BSHO_RSP and HO_PRE_NOTIFICATION_RESPONSE message.

TABLE 2
Required information elements for MOB_BSHO_REQ, MOB_BSHO_RSP and
HO_PRE_NOTIFICATION_RESPONSE message

| Syntax | Size | | Notes |
|---|---|---|---|
| DL_SC_FLAG | 1 | bit | Downlink secondary carrier include flag |
| NUM_DL_SC | 0 or 3 | bits | Number of allocated secondary carrier(s) for downlink |
| | | | transmission |
| For (i=0; | | | |
| i<NUM_DL_SC; | | | |
| i++) { | | | |
| DL_SC_ID | 16 | bits | Downlink secondary carrier id |
| DL_SC_FREQ | 4 | bits | Downlink secondary carrier frequency |
| DL_SC_DURATION | 4 | bits | Allocated occupancy time for downlink (in unit of frame) |
| DL_SC_START | 7 | bits | Start time for allocated downlink secondary carrier (in unit of |
| | | | frame) |
| } | | | |
| UL_SC_FLAG | 1 | bit | Uplink secondary carrier include flag |
| NUM_UL_SC | 0 or 3 | bits | Number of allocated secondary carrier for uplink transmission |
| For (j=0: | | | |
| j<NUM_UL_SC; | | | |
| j++) { | | | |
| UL_SC_ID | 16 | bits | Uplink secondary carrier id |
| UL_SC_FREQ | 4 | bits | Uplink secondary carrier frequency |
| UL_SC_DURATION | 4 | bits | Required occupancy time for uplink (in unit of frame) |
| UL_SC_START | 7 | bits | Start time for allocated uplink secondary carrier (in unit of |
| | | | frame) |
| } | | | |

DL_SC_FLAG: If the BS allocates secondary carrier(s) for downlink transmission during the handoff, the BS has to set this field to “1.”

NUM_DL_SC: If the DL_SC_FLAG is set to “1,” this field may be used to specify a number of allocated secondary carrier(s) for downlink transmission.

DL_SC_ID: The BS may allocate identification to each allocated secondary carrier for downlink transmission.

DL_SC_FREQ: The BS may allocate the frequency information for each allocated secondary carrier for downlink transmission.

DL_SC_DURATION: This field may be used to specify a time duration in frame units. If the BS allocates secondary carrier(s) for downlink transmission to indefinite use, the BS may set “DL_SC_DURATION” to “1111.” When the “DL_SC_DURATION” is set to “1111,” the MS or BS may transmit a secondary carrier release message to release the secondary carrier(s).

DL_SC_START: The start time of the secondary carrier for downlink transmission is measured in frame units.

UL_SC_FLAG: If the BS allocates secondary carrier(s) for uplink transmission during the handoff, the BS may set this field to “1.”

NUM_UL_SC: If the UL_SC_FLAG is set to “1,” this field may be used to specify a number of allocated secondary carriers for uplink transmission.

UL_SC_ID: The BS may allocate identification to each allocated secondary carrier for uplink transmission.

UL_SC_FREQ: The BS may allocate the frequency information for each allocated secondary carrier for uplink transmission.

UL_SC_DURATION: This field may be used to specify a time duration in frame units. If the BS allocates secondary carrier for uplink transmission to indefinite use, the BS may set “UL_SC_DURATION” to “1111.” When the “UL_SC_DURATION” is set to “1111,” the MS or BS may transmit a secondary carrier release message to release the secondary carrier(s).

UL_SC_START: The start time of the secondary carrier for uplink transmission is measured in frame units.

Although the above discussion focuses on the use of frame units to specify a time value, alternate techniques may be used to specify time values. For example, an absolute time value may be used or a relative time or offset referenced to an absolute time may be used. Therefore, the discussion of frame units should not be construed as being limiting to either the spirit or scope of the embodiments.

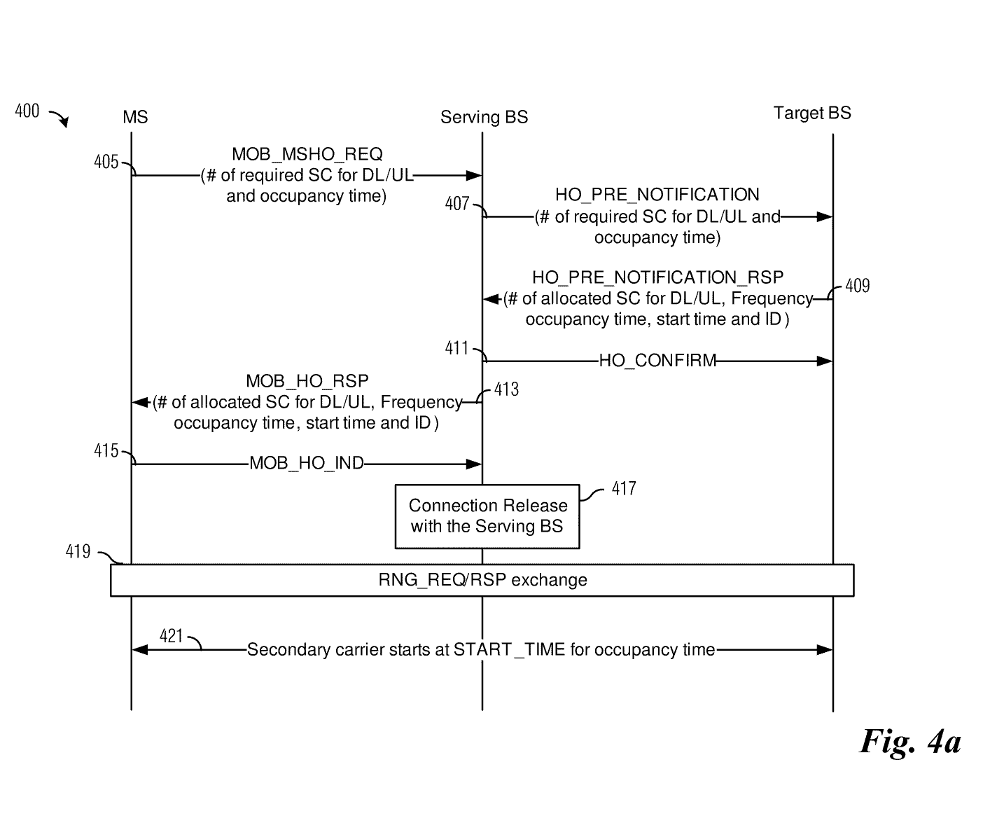

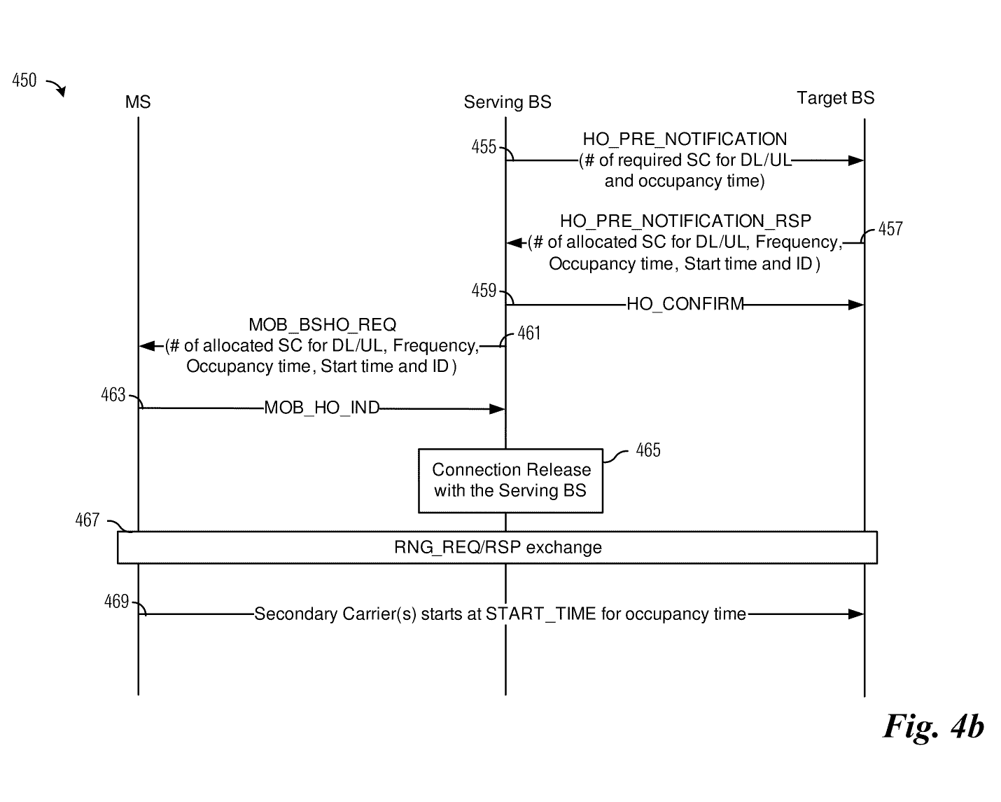

FIG. 4a illustrates a message exchange 400 in a MS initiated handover in a multi-carrier wireless communications system. Message exchange 400 may be illustrative of messages and operations occurring in a MS, a serving BS, and a target BS of a multi-carrier wireless communications system in a MS initiated handover, wherein the serving BS is the current serving BS of the MS and the target BS is a BS that is intended to be the serving BS of the MS after the handover completes.

Using fields as defined in Tables 1 and 2 for existing message types or in a new message type, the MS and the serving BS and the target BS may exchange messages (message exchange 400) to perform a handover in a multi-carrier wireless communications system. Message exchange 400 may begin with the MS determining a number of secondary carrier(s) that it may need to transmit and/or receive information from the serving BS. The MS may also determine a usage time for the secondary carrier(s). The MS may transmit a mobile station handover request (MOB_MSHO_REQ) message to the serving BS (event 405). The mobile station handover request may include fields (as defined in Table 1) specifying a number of downlink and/or uplink secondary carrier(s) as well as a usage time for the secondary carriers.

Rather than expressing the data transmission/reception requirements in terms of a number of secondary receiver(s), the MS may express its data transmission/reception requirements in terms of a bandwidth requirement, i.e., the amount of data that it needs to transmit or receive. The bandwidth requirement of the MS may be expressed in terms of an actual amount of bandwidth that the MS needs to transmit and/or receive information, and may be expressed as a numerical value. However, the bandwidth requirement may also be expressed in other terms. For example, the bandwidth requirement may be expressed as a Quality of Service (QoS) requirement or restriction, a data rate, a bandwidth window (a minimum bandwidth and a maximum bandwidth), and so forth.

In an alternative embodiment, since transmissions to and from the MS are controlled by the serving BS, the serving BS may have a good estimate of the bandwidth requirements of the MS, so rather than having the MS determine the number of secondary carrier(s) that it needs and then transmitting the number of the serving BS (event 405, for example), the MS may simply transmit a mobile station handover request to the serving BS and the serving BS computes the number of secondary carrier(s) that the MS requires.

The serving BS may then send a handover pre-notification (HO_PRE_NOTIFICATION) message to potential target BS(s) (event 407). The handover pre-notification message may include fields (as defined in Table 2) specifying the number of downlink and/or uplink secondary carrier(s) as well as the usage time for the secondary carriers. Potential target BS(s) that may be capable of participating in the handover may transmit a response message (HO_PRE_NOTIFICATION_RSP) in response to the handover pre-notification message (event 409). The response message from the potential target BS(s) may include fields that specify a number of downlink and/or uplink secondary carriers that the potential target BS(s) may be able to allocate to the MS, a usage time, a start time, as well as frequency information and an identification for each secondary carrier. The serving BS may select a target BS out of the possible target BS(s) that responded to the handover pre-notification message and send a handover confirm (HO_CONFIRM) message to the selected target BS, now referred to as a target BS (event 411).

The serving BS may select the target BS from the potential target BS(s) that best matches the number of secondary carriers (or bandwidth) needed by the MS. If more than one potential target BSs may allocate the same number of secondary carriers that best matches the number of secondary carriers needed by the MS, then the serving BS may randomly select the target BS.

The serving BS may send a response message (MOB_HO_RSP) in response to the handover request message from the MS (event 413). The response message may include fields that specify the number of downlink and/or uplink secondary carriers that the potential target BS may be able to allocate to the MS, the usage time, the start time, as well as frequency information and identification for each secondary carrier. The MS may send a handover indicator (MOB_HO_IND) in a message to the serving BS (event 415). The serving BS may then begin operations to release an existing connection with the MS (block 417), while the MS and the target BS may exchange ranging request (RNG_REQ) and response (RNG_RSP) messages to exchange system information and parameters (block 419). Finally, at the start time as specified by the target BS, the MS may begin to use the secondary carrier(s) (event 421).

FIG. 4b illustrates a message exchange 450 in a BS initiated handover in a multi-carrier wireless communications system. Message exchange 450 may be illustrative of messages and operations occurring in a MS, a serving BS, and a target BS of a multi-carrier wireless communications system in a BS initiated handover, wherein the serving BS is the current serving BS of the MS and the target BS is a BS that is intended to be the serving BS of the MS after the handover completes.

Using fields as defined in Tables 1 and 2 for existing message types or in a new message type, the MS and the serving BS and the target BS may exchange messages (message exchange 450) to perform a handover in a multi-carrier wireless communications system. Message exchange 450 may begin with the serving BS sending a handover pre-notification (HO_PRE_NOTIFICATION) message to potential target BS(s) (event 455). The handover pre-notification message may include fields (as defined in Table 2) specifying the number of downlink and/or uplink secondary carrier(s) as well as the usage time for the secondary carriers. Potential target BS(s) that may be capable of participating in the handover may transmit a response message (HO_PRE_NOTIFICATION_RSP) in response to the handover pre-notification message (event 457). The response message from the potential target BS(s) may include fields that specify a number of downlink and/or uplink secondary carriers that the potential target BS(s) may be able to allocate to the MS, a usage time, a start time, as well as frequency information and an identification for each secondary carrier. The serving BS may select a target BS out of the possible target BS(s) that responded to the handover pre-notification message and send a handover confirm (HO_CONFIRM) message to the selected target BS, now referred to as a target BS (event 459).

The serving BS may transmit a base station handover request (MOB_BSHO_REQ) message to the MS (event 461). The base station handover request may include fields that specify the number of downlink and/or uplink secondary carriers that the target BS may be able to allocate to the MS, the usage time, the start time, as well as frequency information and identification for each secondary carrier. The MS may send a handover indicator (MOB_HO_IND) in a message to the serving BS (event 463). The serving BS may then begin operations to release an existing connection with the MS (block 465), while the MS and the target BS may exchange ranging request (RNG_REQ) and response (RNG_RSP) messages to exchange system information and parameters (block 467). Finally, at the start time as specified by the target BS, the MS may begin to use the secondary carrier(s) (event 469).

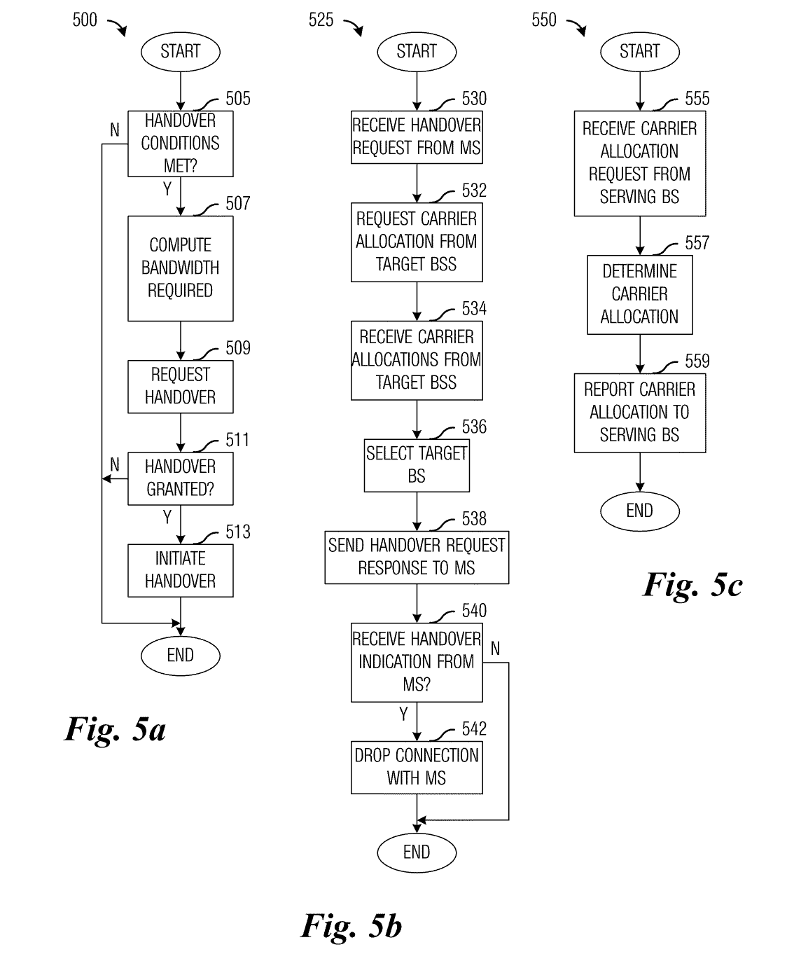

FIG. 5a illustrates a flow diagram of MS operations 500 in a MS initiated handover in a multi-carrier wireless communications system. MS operations 500 may be indicative of operations occurring in a MS operating in a multi-carrier wireless communications system. MS operations 500 may occur while the MS is operating in a normal operating mode and while the MS detects that conditions are conducive for a handover.

MS operations 500 may begin with the MS determining that handover conditions are met (block 505). Handover conditions may be met when the MS detects that transmissions from its serving BS have dropped below a first threshold, while it detects that transmissions from potential target BS(s) have exceeded a second threshold, for example. Alternatively, the MS may have determined that it has moved to an edge of a coverage area of its serving BS, for example. The MS may determine its position in the coverage area through the use of positioning commands, telemetry data, information provided by its serving BS, and so forth. If the handover conditions are not met, then MS operations 500 may then terminate.

The MS may also compute its bandwidth requirements (block 507). The bandwidth requirements of the MS may be determined in a downlink direction, an uplink direction, or for both directions. From the bandwidth requirements, the MS may determine a number of secondary carrier(s) that it will need to satisfy the bandwidth requirements. If the secondary carriers in the multi-carrier wireless communications system are all of the same bandwidth, then the bandwidth requirement of the MS and the number of secondary carrier(s) may be directly related. However, if the bandwidth of the secondary carriers are not all the same, then the MS may decide to forgo determining the number of secondary carrier(s) that it needs and leave the computation to the serving BS.

The bandwidth requirement of the MS may be expressed in terms of an actual amount of bandwidth that the MS needs to transmit and/or receive information, and may be expressed as a numerical value. However, the bandwidth requirement may also be expressed in other terms. For example, the bandwidth requirement may be expressed as a Quality of Service (QoS) requirement or restriction, a data rate, a bandwidth window (a minimum bandwidth and a maximum bandwidth), and so forth.

As discussed previously, since the serving BS controls transmissions to and from the MS, the serving BS may have a good estimate of the bandwidth requirements of the MS. Therefore, in an alternative embodiment, the MS may not need to compute its own bandwidth requirements. Rather, the serving BS may compute the bandwidth requirements of the MS.

The MS may request a handover by transmitting a mobile station handover request (MOB_MSHO_REQ) message to the serving BS (block 509). The mobile station handover request may include fields (as defined in Table 1) specifying a number of downlink and/or uplink secondary carrier(s) (or the bandwidth) as well as a usage time for the secondary carriers.

The MS may then perform a check to determine if the serving BS has granted its request for the handover (block 511). If the serving BS has granted the MS's request for the handover, the serving BS may transmit to the MS a response message (MOB_HO_RSP) in response to the handover request message from the MS. The response message may include fields that specify the number of downlink and/or uplink secondary carriers that the target BS may be able to allocate to the MS, the usage time, the start time, as well as frequency information and an identification for each secondary carrier.

If the serving BS has granted the handover to the MS, the MS may initiate the handover (block 513). The MS may initiate the handover by sending a handover indicator (MOB_HO_IND) in a message to the serving BS. The connection between the MS and the serving BS may then be terminated and the MS and the target BS may exchange messages so that the target BS becomes the serving BS for the MS. At the start time specified by the target BS (now the serving BS), the MS may begin to use the secondary carrier(s) allocated to it and MS operations 500 may terminate.

If the serving BS has not granted the handover to the MS, then MS operations 500 may then terminate.

FIG. 5b illustrates a flow diagram of serving BS operations 525 in a MS initiated handover in a multi-carrier wireless communications system. Serving BS operations 525 may be indicative of operations occurring in a serving BS operating in a multi-carrier wireless communications system. Serving BS operations 525 may occur while the serving BS is operating in a normal operating mode.

Serving BS operations 525 may begin with the serving BS receiving a handover request (MOB_MSHO_REQ) message from the MS (block 530). The mobile station handover request may include fields (as defined in Table 1) specifying a number of downlink and/or uplink secondary carrier(s) (or the bandwidth) as well as a usage time for the secondary carriers.

The serving BS may request secondary carrier allocations from potential target BS(s) of the MS (block 532). The serving BS may request secondary carrier allocations from potential target BS(s) by sending a handover pre-notification (HO_PRE_NOTIFICATION) message to potential target BS(s). The handover pre-notification message may include fields (as defined in Table 2) specifying the number of downlink and/or uplink secondary carrier(s) as well as the usage time for the secondary carriers. Potential target BS(s) that may be capable of participating in the handover may transmit a response message (HO_PRE_NOTIFICATION_RSP) in response to the handover pre-notification message (block 534). The response message from the potential target BS(s) may include fields that specify a number of downlink and/or uplink secondary carriers that the potential target BS(s) may be able to allocate to the MS, a usage time, a start time, as well as frequency information and an identification for each secondary carrier. The serving BS may select a target BS out of the possible target BS(s) that responded to the handover pre-notification message (block 536) and send a handover confirm (HO_CONFIRM) message to the selected target BS, now referred to as a target BS.

The serving BS may send a response message (MOB_HO_RSP) in response to the handover request message from the MS (block 538). The response message may include fields that specify the number of downlink and/or uplink secondary carriers that the target BS may be able to allocate to the MS, the usage time, the start time, as well as frequency information and an identification for each secondary carrier.

The serving BS may then receive a handover indicator (MOB_HO_IND) in a message from the MS (block 540). If the serving BS does not receive the handover indicator from the MS, then serving BS operations 525 may then terminate.

If the serving BS does receive the handover indicator from the BS, then the serving BS may drop its connection with the MS (block 542) and then serving BS operations 525 may then terminate.

FIG. 5c illustrates a flow diagram of target BS operations 550 in a MS initiated handover in a multi-carrier wireless communications system. Target BS operations 550 may be indicative of operations occurring in a target BS operating in a multi-carrier wireless communications system. Target BS operations 550 may occur while the target BS is operating in a normal operating mode.

Target BS operations 550 may begin with the target BS receiving a handover pre-notification (HO_PRE_NOTIFICATION) message from the serving BS of the MS (block 555). The handover pre-specification message may include a number of secondary carrier(s) needed by a MS. The handover pre-notification message may include fields (as defined in Table 2) specifying the number of downlink and/or uplink secondary carrier(s) as well as the usage time for the secondary carriers. The target BS may then determine a secondary carrier allocation for the MS based on the information provided in the handover pre-notification message (block 557). The secondary carrier allocation may allocate to the MS all of the secondary carriers (i.e., bandwidth) that it has requested or the secondary carrier allocation may allocate only a sub-set of the secondary carriers that the MS has requested.

In addition to allocating secondary carriers, the target BS may also determine a time duration of the allocation as well as starting times, frequencies, identification, and so forth. The target BS may transmit a response message (HO_PRE_NOTIFICATION_RSP) in response to the handover pre-notification message (block 559). The response message from the target BS may include fields that specify a number of downlink and/or uplink secondary carriers that the target BS may be able to allocate to the MS, a usage time, a start time, as well as frequency information and identification for each secondary carrier. Target BS operations 550 may then terminate.

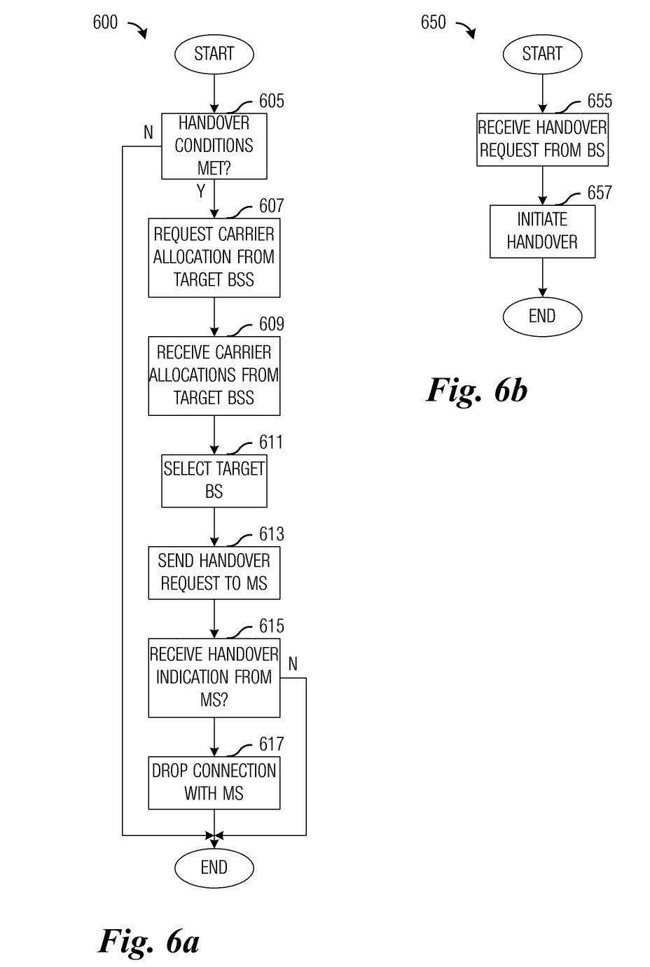

FIG. 6a illustrates a flow diagram of serving BS operations 600 in a serving BS initiated handover in a multi-carrier wireless communications system. Serving BS operations 600 may be indicative of operations occurring in a serving BS operating in a multi-carrier wireless communications system. Serving BS operations 600 may occur while the serving BS is operating in a normal operating mode.

Serving BS operations 600 may begin with the serving BS determining that handover conditions for the MS are met (block 605). Handover conditions for the MS may be met when the serving BS determines that transmissions to the MS have dropped below a first threshold, while it detects that transmissions from potential target BS(s) have exceeded a second threshold, for example. Alternatively, the serving BS may have determined that the MS has moved to an edge of its coverage area, for example. The serving BS may determine the position of the MS in the coverage area through the use of positioning commands, telemetry data, information provided by the serving BS, and so forth. If the handover conditions are not met, then serving BS operations 600 may then terminate.

The serving BS may request secondary carrier allocations from potential target BS(s) of the MS (block 607). The serving BS may request secondary carrier allocations from potential target BS(s) by sending a handover pre-notification (HO_PRE_NOTIFICATION) message to potential target BS(s). The handover pre-notification message may include fields (as defined in Table 2) specifying the number of downlink and/or uplink secondary carrier(s) as well as the usage time for the secondary carriers. Potential target BS(s) that may be capable of participating in the handover may transmit a response message (HO_PRE_NOTIFICATION_RSP) in response to the handover pre-notification message (block 609). The response message from the potential target BS(s) may include fields that specify a number of downlink and/or uplink secondary carriers that the potential target BS(s) may be able to allocate to the MS, a usage time, a start time, as well as frequency information and an identification for each secondary carrier. The serving BS may select a target BS out of the possible target BS(s) that responded to the handover pre-notification message (block 611) and send a handover confirm (HO_CONFIRM) message to the selected target BS, now referred to as a target BS.

The serving BS may send a base station handover request (MOB_BSHO_REQ) message to the MS (block 613). The base station handover request may include fields that specify the number of downlink and/or uplink secondary carriers that the target BS may be able to allocate to the MS, the usage time, the start time, as well as frequency information and identification for each secondary carrier.

The serving BS may then receive a handover indicator (MOB_HO_IND) in a message from the MS (block 615). If the serving BS does not receive the handover indicator from the MS, then serving BS operations 600 may then terminate.

If the serving BS does receive the handover indicator from the BS, then the serving BS may drop its connection with the MS (block 617) and then serving BS operations 600 may then terminate.

FIG. 6b illustrates a flow diagram of MS operations 650 in a serving BS initiated handover in a multi-carrier wireless communications system. MS operations 650 may be indicative of operations occurring in a MS operating in a multi-carrier wireless communications system. MS operations 650 may occur while the MS is operating in a normal operating mode and while the serving BS detects that conditions are conducive for a handover.

MS operations 650 may begin with the MS receiving a base station handover request (MOB_BSHO_REQ) message from the serving BS (block 655). The base station handover request may include fields that specify the number of downlink and/or uplink secondary carriers that the target BS may be able to allocate to the MS, the usage time, the start time, as well as frequency information and identification for each secondary carrier. The MS may respond with a handover indicator (MOB_HO_IND) in a message to the serving BS, which may initiate the handover (block 657). With the handover initiated, the connection between the MS and the serving BS may then be terminated and the MS and the target BS may exchange messages so that the target BS becomes the serving BS for the MS. At the start time specified by the target BS (now the serving BS), the MS may begin to use the secondary carrier(s) allocated to it and MS operations 650 may terminate.

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for communications device operation in a multi-carrier communications system, the method comprising:
computing a bandwidth requirement;
transmitting a handover request to a server controller, wherein the handover request comprises the bandwidth requirement;
receiving a response responsive to the handover request; and
in response to determining that the handover request was granted, initiating a handover.

2. The method of claim 1, wherein the computing, the transmitting, the receiving, and the in response to determining, are performed in response to determining that handover conditions are met.

3. The method of claim 2, wherein determining that handover conditions are met comprises:
determining that transmissions from the server controller are below a first threshold; and
determining that transmissions from a target controller are above a second threshold.

4. The method of claim 2, wherein determining that handover conditions are met comprises:
determining that the communications device is operating at an edge of a coverage area of the server controller; and
determining that transmissions from a target controller are above a third threshold.

5. The method of claim 1, wherein computing a bandwidth requirement comprises:
computing an uplink bandwidth requirement for transmissions from the communications device to a serving controller; or
computing a downlink bandwidth requirement for transmissions from the serving controller to the communications device.

6. The method of claim 1, wherein the multi-carrier communications system comprises a primary carrier and at least one secondary carrier, and wherein the bandwidth requirement comprises a number of secondary carriers.

7. The method of claim 1, wherein computing a bandwidth requirement further comprises, computing a usage time for the bandwidth requirement.

8. The method of claim 1, wherein initiating a handover comprises, transmitting a message comprising a handover indication to the server controller.

9. A method for server controller operation, the method comprising:
receiving a handover request from a communications device, the handover request comprising a bandwidth requirement;
requesting a carrier allocation from each of one or more potential target controllers, wherein each carrier allocation is based on the bandwidth requirement;
receiving the carrier allocation from each of the one or more potential target controllers;
selecting a target controller from the one or more potential target controllers, wherein the selecting is based on the carrier allocations from the one or more potential target controllers; and
sending a response to the handover request to the communications device, wherein the response comprises the carrier allocation from the selected target controller.

10. The method of claim 9, wherein the server controller operates in a multi-carrier communications system, wherein the multi-carrier communications system comprises a primary carrier and at least one secondary carrier, and wherein each carrier allocation comprises an allocation of the primary carrier.

11. The method of claim 10, wherein each carrier allocation further comprises an allocation of at least one secondary carrier, wherein the allocation of the at least one secondary carrier is based on the bandwidth requirement.

12. The method of claim 9, further comprising:
receiving a handover indication from the communications device; and
dropping a connection between the communications device and the server controller.

13. The method of claim 12, wherein dropping a connection comprises, dropping the connection between the communications device and the server controller in response to determining that the communications device wants to participate in the handover.

14. The method of claim 9, wherein selecting a target controller comprises, selecting a target controller from the one or more potential target controllers with a carrier allocation that satisfies the bandwidth requirement.

15. The method of claim 14, wherein at least two potential target controllers have carrier allocations that satisfies the bandwidth requirement, and wherein selecting a target controller comprises, randomly selecting a target controller from the at least two potential target controllers.

16. The method of claim 9, wherein the response comprises a number of carriers that the target controller can allocate to the communications device, a usage time, a start time, as well as frequency information and identification for each carrier.

17. A method for target controller operation, the method comprising:
receiving a carrier allocation request from a serving controller, the carrier allocation request comprising a secondary carrier requirement of a communications device;
determining a carrier allocation based on the carrier allocation request; and
transmitting the carrier allocation to the serving controller.

18. The method of claim 17, further comprising, establishing a connection with the communications device.

19. The method of claim 17, wherein the carrier allocation comprises a number of carriers that the target controller can allocate to the communications device, a usage time, a start time, as well as frequency information and identification for each carrier.

20. The method of claim 19, wherein the carrier allocation is further based on available carriers, network conditions, a priority level of the communications device, current carrier allocation to the communications device, or combinations thereof.

21. A method for server controller operation, the method comprising:
requesting a carrier allocation from one or more potential target controllers, wherein the carrier allocation is based on a secondary carrier requirement of a communications device;
receiving one or more carrier allocations from the one or more potential target controllers;
selecting a target controller from the one or more potential target controllers, wherein the selecting is based on the one or more carrier allocations from the one or more potential target controllers; and
sending a handover request to the communications device.

22. The method of claim 21, wherein the requesting, the receiving, the selecting, and the sending are performed in response to determining that handover conditions at the communications device are met.

23. The method of claim 21, further comprising:
receiving a handover indication from the communications device; and
dropping a connection between the communications device and the server controller.

24. The method of claim 21, wherein the secondary carrier requirement comprises a number of secondary carriers required by the communications device.
